(19) United States
(12) Patent Application Publication
(10) Pub. No.: US 2007/0064039 A1
(43) Pub. Date: Mar. 22, 2007

(54) Apparatus and method of detecting abnormal condition of printhead

(75) Inventor: Jung-hwan Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/501,861

(22) Filed: Aug. 10, 2006

(30) Foreign Application Priority Data
Sep. 21, 2005 (KR) 2005-87858

(51) Int. Cl. B41J 29/393

(52) U.S. Cl. 347/19

(57) ABSTRACT

An apparatus and method of detecting an abnormal condition of a printhead includes a voltage stabilizing unit to stabilize a voltage of a power supplied to the printhead, a voltage measuring unit to measure the stabilized voltage, and an abnormal condition detecting unit to compare the measured voltage in a predetermined time and a critical voltage to detect an abnormal condition of the printhead.

### CROSS-REFERENCE TO RELATED APPLICATIONS

This application claims priority under 35 U.S.C. §119(a) from Korean Patent Application No.10-2005-0087858, filed on Sep. 21, 2005 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an apparatus and method of detecting an abnormal condition of a printhead in a full page width printer using a charging time or a discharging time of a capacitor stabilizing a voltage of a power supply unit that supplies power to the printhead.

2. Description of the Related Art

Generally, to detect an abnormal condition of a conventional printhead illustrated in FIG. 1, a test power is supplied via a resistance with a connection line which is originally for supplying power to the printhead, and a voltage distributed by the resistance is compared with the standard voltage.

For this, a driving power supplied to the printhead is turned off and an additional test power is turned on. Then, after the abnormal condition of the printhead is checked, and the test power is turned off and the driving power is turned on again.

However, since additional devices such as a power driver and a voltage comparator for supplying the additional test power are provided for the conventional apparatus for detecting the abnormal condition of the printhead, manufacturing costs increase. Moreover, as the driving power supplied to the printhead must be turned off, the detection becomes time-consuming and inconvenient for the user.

### SUMMARY OF THE INVENTION

The present general inventive concept provides an apparatus and method of detecting an abnormal condition of a printhead using a charging time or a discharging time of a capacitor stabilizing a voltage of a power supplied to the printhead.

Additional aspects and advantages of the present general inventive concept will be set forth in part in the description which follows and, in part, will be obvious from the description, or may be learned by practice of the general inventive concept

The foregoing and/or other aspects of the present general inventive concept may be achieved by providing an apparatus to detect an abnormal condition of a printhead, the apparatus including a voltage stabilizing unit to stabilize a voltage of a power supplied to the printhead, a voltage measuring unit to measure a stabilized voltage of the voltage stabilizing unit, and an abnormal condition detecting unit to compare the measured voltage and a critical voltage to detect an abnormal condition of the printhead in a predetermined time.

The voltage stabilizing unit may be a capacitor.

The abnormal condition detecting unit may include a voltage comparing unit to compare the measured voltage with the critical voltage in the predetermined time and to output the voltage comparison result, and the abnormal condition detecting unit to detect the abnormal condition in response to the voltage comparison result.

The foregoing and/or other aspects of the present general inventive concept may be achieved by providing an apparatus to detect an abnormal condition of a printhead, the apparatus including a power supply unit to supply a power to the printhead, a voltage stabilizing unit to stabilize a voltage of the power supplied to the printhead, a voltage measuring unit to measure the stabilized voltage, a time measuring unit to measure a period of time in which the stabilized voltage reaches a predetermined voltage, and an abnormal condition detecting unit to compare the measured time with a critical time to detect an abnormal condition of the printhead.

The voltage stabilizing unit may be a capacitor.

The abnormal condition detecting unit may comprise a time comparing unit to compare the measured time with a critical time and to output a time comparison result, and the abnormal condition detecting unit to operate in response to the time comparison result to detect the abnormal condition of the printhead.

The foregoing and/or other aspects of the present general inventive concept may be achieved by providing a method of detecting an abnormal condition of the printhead including a capacitor stabilizing a voltage of a power supplied to the printhead, the method comprising supplying power to the capacitor, detecting the voltage of the capacitor in a predetermined time, and comparing the measured voltage with a critical voltage and detecting an abnormal condition of the printhead.

The comparing of the measured voltage with the critical voltage may comprise comparing the measured voltage with the critical voltage, and determining that the printhead is in the abnormal condition when the measured voltage is greater than the critical voltage.

The foregoing and/or other aspects of the present general inventive concept may be achieved by providing a method of detecting an abnormal condition of the printhead including a capacitor stabilizing a voltage of a power supply unit supplying power to the printhead, the method comprising stopping supplying power to the capacitor, measuring a voltage of the capacitor in a predetermined time, and comparing the measured voltage with a critical voltage and detecting an abnormal condition of the printhead.

The detecting of the abnormal condition may comprise comparing the measured voltage with the critical voltage, and determining that the printhead is in the abnormal condition when the measured voltage is smaller than the critical voltage.

The foregoing and/or other aspects of the present general inventive concept may be achieved by providing a method of detecting an abnormal condition of the printhead including a capacitor stabilizing the voltage of a power supply unit supplying power to the printhead, the method comprising: supplying power to the printhead, measuring a time in which the voltage of the capacitor reached the predetermined voltage, and comparing the measured voltage with a critical voltage and detecting an abnormal condition of the printhead.

The comparing of the measured time with the critical time may comprise comparing the detected time with a critical time, and determining that the printhead is in the abnormal condition when the measured time is shorter than the critical time.

The foregoing and/or other aspects of the present general inventive concept may be achieved by providing a method of detecting an abnormal condition of the printhead including a capacitor stabilizing a voltage of power supplied to the printhead, the method comprising stopping supplying power to the printhead, detecting a time in which a voltage of the capacitor reaches a predetermined voltage, and comparing the measured time with a critical time and detecting an abnormal condition of the printhead.

The comparing of the measured time with the critical time may comprise comparing the measured time with the critical time; and determining that the printhead is in the abnormal condition when the measured time is shorter than the critical time.

The foregoing and/or other aspects of the present general inventive concept may be achieved by providing a computer readable medium having embodied thereon a computer program to execute the above-described methods.

The foregoing and/or other aspects of the present general inventive concept may be achieved by providing an apparatus to detect an abnormal condition of a printhead, the apparatus including a power supply unit to supply a power to a printhead, a voltage stabilizing unit to stabilize a voltage of the power supplied to the printhead, a measuring unit to measure the stabilized voltage of the voltage stabilizing unit and a period of time in which the stabilized voltage reaches a predetermined voltage, and an abnormal condition detecting unit to detect an abnormal condition of the printhead according to the measured voltage and the measured period of time.

The foregoing and/or other aspects of the present general inventive concept may be achieved by providing an image forming apparatus to detect an abnormal condition of a printhead, the image forming apparatus including a power supply unit to supply a power to a printhead, a voltage stabilizing unit to stabilize a voltage of the power supplied to the printhead, a measuring unit to measure a voltage variation and a time variation of the voltage of the voltage stabilizing unit, and an abnormal condition detecting unit to detect an abnormal condition of the printhead according to the measured voltage variation and the measured time variation.

The foregoing and/or other aspects of the present general inventive concept may be achieved by providing an image forming apparatus to detect an abnormal condition of a printhead, the image forming apparatus including a power supply unit to supply a power to a printhead, a voltage stabilizing unit to stabilize a voltage of the power supplied to the printhead, a measuring unit to measure a time variation with respect to a variation of the voltage of the voltage stabilizing unit, and an abnormal condition detecting unit to detect a condition of at least one of the printhead and the power supply unit according to the measured time variation.

The foregoing and/or other aspects of the present general inventive concept may be achieved by providing an image forming apparatus to detect an-abnormal condition of a printhead, the image forming apparatus including a power supply unit to supply a power to a printhead, a voltage stabilizing unit to stabilize a voltage of the power supplied to the printhead, a measuring unit to measure a voltage variation with respect to a variation of a time taken to reach from a first value to a second value of the voltage of the voltage stabilizing unit, and an abnormal condition detecting unit to detect a condition of at least one of the printhead and the power supply unit according to the measured voltage variation.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a conventional printhead;

FIG. 2 is a block diagram illustrating an apparatus to detect an abnormal condition of a printhead according to an embodiment of the present general inventive concept;

FIGS. 3A and 3B are graphs illustrating time variations and a voltage of a capacitor of the apparatus of FIG. 2 to illustrate a method of detecting the abnormal condition of the printhead;

FIG. 4 is a circuit diagram illustrating the apparatus of FIG. 2;

FIG. 5 is a flowchart illustrating a method of detecting an abnormal condition of a printhead according to an embodiment of the present general inventive concept; and

FIGS. 6A and 6B are flowcharts illustrating a method of detecting an abnormal condition of a printhead according to another embodiment of the present general inventive concept.

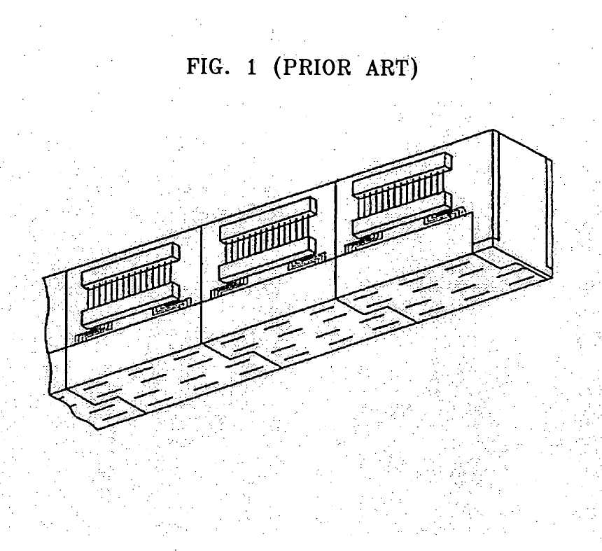

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

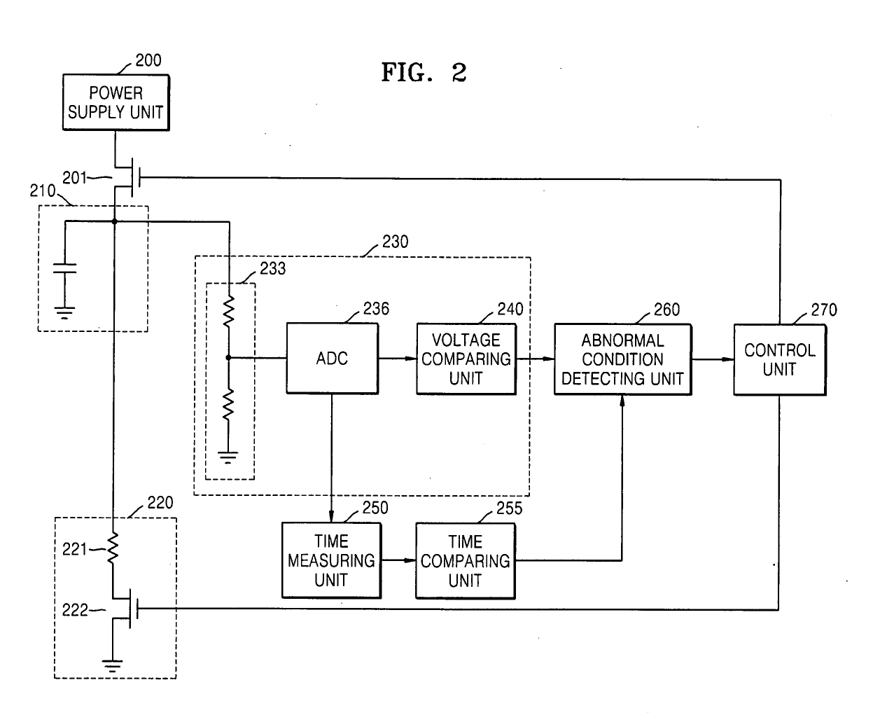

FIG. 2 is a block diagram illustrating an apparatus to detect an abnormal condition of a printhead according to an embodiment of the present general inventive concept. The apparatus of FIG. 2 is usable with a printhead 220 which includes a heater 221 or piezoelectric device as a driving source to eject ink through a nozzle and a second switch 222 to control an operation of the heater 221, and/or an image forming apparatus, and includes a power supply unit 200, a voltage stabilizing unit 210, a printhead 220, a voltage measuring unit 230, a voltage comparing unit 240, a time measuring unit 250, a time comparing unit 255, an abnormal condition detecting unit 260, and a control unit 270.

The power supply unit 200 supplies a power to drive the printhead 220. The voltage stabilizing unit 210 stabilizes a voltage of the power supplied to the printhead 220 to compensate for temporary voltage drops and to control the power supply unit 220 to transfer a constant power to the printhead 220, since the voltage of the power supply unit 200 does not vary by more than plus/minus 2 % from a desired or required voltage. The voltage stabilizing unit 210 may be a capacitor. A first switch 201 is disposed between the voltage stabilizing unit 210 and the power supply unit 200 to be open and closed according to a control of the control unit 270.

The voltage measuring unit 230 measures the stabilized voltage in the voltage stabilizing unit 210. The voltage measuring unit 230 includes a voltage dividing unit 233 and an analog-to-digital converter (ADC) 236.

The voltage dividing unit 233 includes a plurality of resistances to divide the voltage stabilized in the voltage stabilizing unit 210. The ADC 236 converts an analog value of the divided voltage output from the voltage dividing unit 233 into a digital value (digital voltage).

The voltage comparing unit 240 compares the voltage converted in the ADC 236 during a predetermined period of time with a critical voltage and sends a voltage comparison result to the abnormal condition detecting unit 260. The time measuring unit 250 measures a time in which the voltage converted in the ADC 236 reaches a predetermined voltage. Then the time comparing unit 255 compares the time in which the voltage converted in the ADC 236 reaches the predetermined voltage with a predetermined time and sends a time comparison result to the abnormal condition detecting unit 260.

The abnormal condition detecting unit 260 operates in response to the voltage comparison result received from the voltage comparing unit 240 and the time comparison result received from the time comparing unit 255 to determine whether the printhead 220 is in an abnormal condition. The abnormal condition of the printhead 220 may be referred to as a case where a connection line to supply the power to the printhead 220 is short-circuited.

The control unit 270 controls the power supplied to the printhead 220 and the driving of the printhead 220, and responds to a detection result of the abnormal condition detecting unit 260 to control the printhead 220 overall.

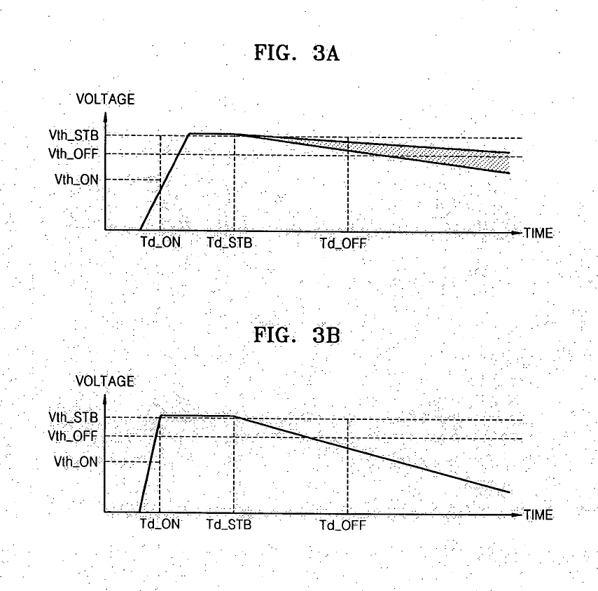

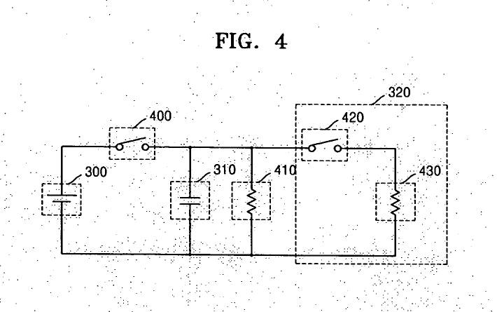

FIGS. 3A and 3B are graphs illustrating time variations of the voltage of the capacitor to describe a method of detecting the abnormal condition of the printhead of FIG. 2. Also, FIG. 4 is a circuit diagram illustrating the apparatus and method of FIGS. 2, 3A, and 3B.

A first switch 400 controls the power supplied from a power supplier 300 to a printhead 320 having a heater 430 or piezoelectric device as a driving source to eject ink through a nozzle and a second switch 420 to control an operation of the heater 430. When the first switch 400 is closed, a capacitor 310 is charged according to the following equation:

$$v ( t ) = Vph ( 1 - {ɛ}^{\frac{1}{Rload \times C} \times t} ) \qquad [ Equation 1 ]$$

where v(t) is the voltage of the capacitor 310 during time t, Vph is the voltage supplied from the power supply unit 300, Rload is the resistance of a resistance 410, and C is the capacitance of the capacitor 310.

When the first switch 400 is opened, the capacitor 310 is discharged according to the following equation:

$$v ( t ) = Vph \times {ɛ}^{- \frac{1}{Rload \times C} \times t} \qquad [ Equation 2 ]$$

It is noted from Equations 1 and 2, that when Vph, C, and t are constant, v(t) varies with Rload. Accordingly, when there is a short circuit between the power supply unit 300 and the ground, Rload is reduced.

The graph of FIG. 3A illustrates the time variation and the voltage of the capacitor 310 when the printhead 320 is in a normal condition and when the power supply unit 300 is not short-circuited. The graph of FIG. 3B illustrates the time variation and the voltage of the capacitor 310 when the power supply unit 300 is short-circuited and/or the printhead 320 is in a short-circuited, abnormal, or malfunction state.

Td_ON is a time during which it is determined whether the voltage of the capacitor 310 is larger than the critical voltage Vth_ON. When the printhead is in the normal condition during the time Td_ON, as illustrated FIG. 3A, the voltage of the capacitor 310 is not larger than the critical voltage Vth_ON. However, when the power supply unit 300 is short-circuited, the voltage of the capacitor 310 is larger than the critical voltage Vth_ON as illustrated in FIG. 3B.

Td_STB is a time during which the first switch 400 is opened from a closed state according to a determination of whether the capacitor 310 is charged to a saturation voltage Vth_STB.

Td_OFF is a time during which it is determined whether the voltage of the capacitor 310 is larger than a critical voltage Vth_OFF after the first switch 400 is opened. The voltage of the capacitor 310 is larger than a critical voltage Vth_OFF when the printhead is in a normal condition during the time Td_OFF as ill 3A. However, as illustrated in FIG. 3B, the voltage of the capacitor 310 is smaller than the critical voltage Vth_OFF when the power supply unit 300 is short-circuited.

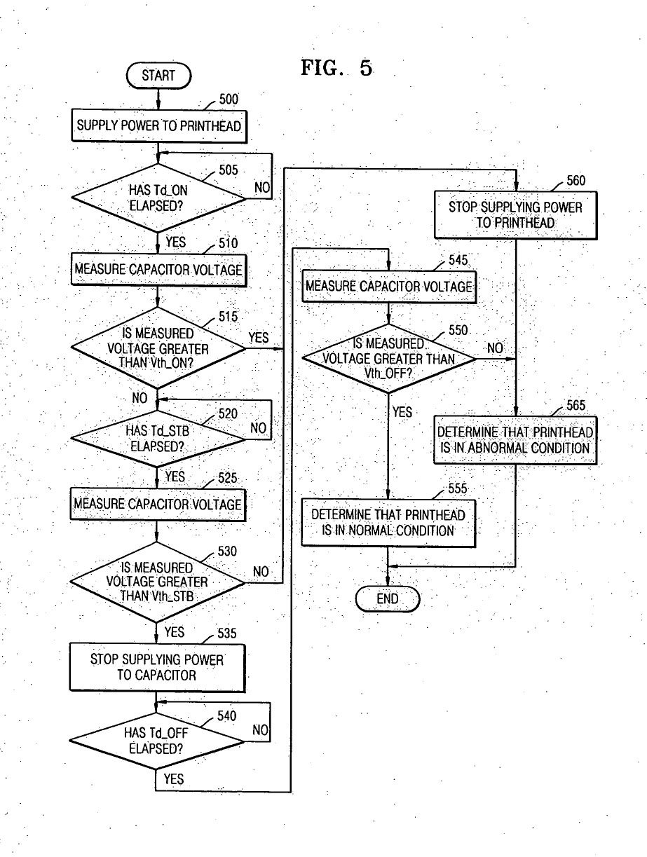

FIG. 5 is a flowchart illustrating a method of detecting an abnormal condition of a printhead according to an embodiment of the present general inventive concept. The method will be explained in conjunction with FIGS. 3A, 3B, and 4.

In operation 500, the first switch 400 is closed and the power supply unit 300 supplies power to the printhead 320 via the capacitor 310 provided to stabilize the voltage supplied to the printhead 320.

Then, in operation 505, it is determined whether the time Td_ON has elapsed.

If it was determined in the operation 505 that the time Td_ON has elapsed, the voltage of the capacitor 310 is measured in operation 510.

In operation 515, the voltage measured in the operation 510 is compared with the critical voltage Vth_ON.

If it was determined in the operation 515 that the voltage measured in the operation 510 is greater than the critical voltage Vth_ON, the first switch 400 is opened to stop the supply of power from the power supply unit 300 in operation 560. Then, in operation 565, the printhead is determined to be in an abnormal condition and the method is stopped.

If it was determined in the operation 515 that the voltage measured in the operation 510 is smaller or not greater than the critical voltage Vth_ON, it is determined whether the time Td_STB has elapsed in operation 520.

If it was determined in the operation 520 that the time Td_STB has elapsed, the voltage of the capacitor 310 is measured in operation 525.

The voltage measured in the operation 525 is compared with the saturation voltage Vth_STB in operation 530.

If it is determined in the operation 530 that the voltage measured in the operation 525 is smaller or not greater than the saturation voltage Vth_STB, it is determined that the printhead is abnormal, and the operations 560 and 565 are performed and the method is stopped.

If it is determined in the operation 530 that the voltage measured in the operation 525 is greater than the saturation voltage Vth_STB, in operation 535, the supply of power from the power supply unit 300 is stopped, and in operation 540, it is determined whether the time Td_OFF has passed.

If the time Td_OFF has not elapsed, the operation 540 is repeated. Otherwise, in operation 545 the voltage of the capacitor 310 is measured, and in operation 550 it is checked whether the voltage measured in the operation 545 is greater than the critical voltage Vth_OFF. Then, in operation 555 if it was determined that the voltage measured in the operation 550 is greater than the critical voltage Vth_OFF, it is determined that the printhead 320 is in a normal condition.

Otherwise, in the operation 565, if it was determined that the voltage measured in the operation 550 is smaller than the critical voltage Vth_OFF, it is determined that the printhead 320 is in an abnormal condition. The abnormal condition of the printhead 320 refers to a case where a connection line for supplying power to the printhead 320 is grounded.

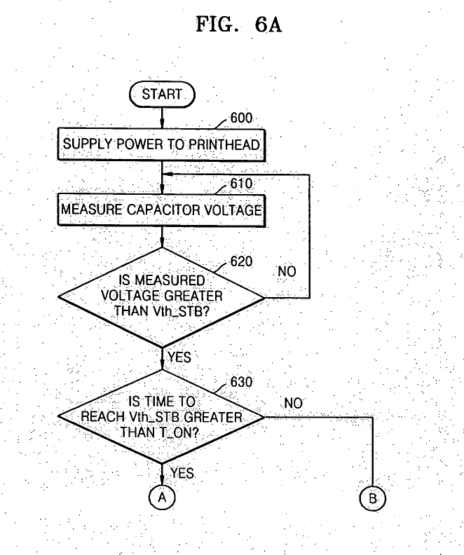

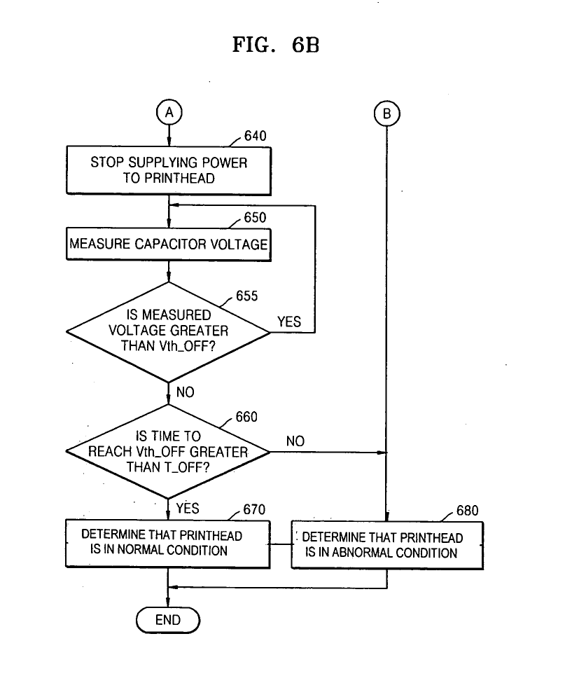

FIGS. 6A and 6B are flowcharts illustrating a method of detecting an abnormal condition of a printhead according to another embodiment of the present general inventive concept.

Referring to FIGS. 3A, 3B, 4, and 6A-6B, a power supply unit supplies power to a printhead via a capacitor provided to stabilize the voltage of the power supply unit.

In operation 610, the voltage of the capacitor is measured.

In operation 620, it is determined whether the voltage of the capacitor measured in the operation 610 reached the saturation voltage Vth_STB.

If the voltage of the capacitor reached the saturation voltage Vth_STB, in operation 630 it is compared the time taken to reach Vth_STB with the time T_ON during which power is supplied to the printhead.

In operation 680, if the time in which the capacitor reached the saturation voltage Vth_STB is shorter than the time T_ON, it is determined that the printhead is in an abnormal condition and/or the power supply unit is short-circuit. The abnormal condition here is referred to as a case when there is a short circuit between a ground potential and a connection line to supply the power to the printhead and ground.

In operation 640, if the time taken to reach the saturation voltage Vth_STB is longer than the time T_ON, the supply of power to the capacitor is stopped.

Then, in operation 650, the voltage of the capacitor is measured.

Then, in operation 655, the voltage measured in operation 650 and a critical voltage Vth_OFF are compared.

If it was determined in the operation 655 that the measured voltage is smaller than the critical voltage Vth_OFF, the method goes back to the operation 650 and the voltage of the capacitor is measured again.

If it was determined in the operation 655 that the measured voltage is greater than the critical voltage Vth_OFF, in operation 660, the time in which the capacitor reached the critical voltage Vth_OFF and the time T_OFF are compared.

In operation 670, if it was determined in the operation 660 that the time in which the capacitor reached the critical voltage Vth_OFF is longer than the time T_OFF, the printhead is determined to be in a normal condition.

If it was determined in the operation 660 that the time taken to reach the critical voltage Vth_OFF is shorter than the time T_OFF, the printhead is determined to be in an abnormal condition.

According to the apparatus and method of detecting an abnormal condition of a printhead according to the present embodiment, when a second switch 420 controlling a heat dissipation unit 430 is opened, the abnormal condition of the printhead can be detected even when the printhead is working.

The general inventive concept can also be embodied as computer readable codes on a computer including all data processing apparatus readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and so on.

According to the apparatus and method of the present general inventive concept, an abnormal condition of the printhead is detected using the charging time or the discharging time of a capacitor which stabilizes the voltage of the power supplied to the printhead.

Thus a mechanical malfunction or damage of the printhead can be prevented and an image forming apparatus having the printhead can be used more safely. Also, since an abnormal condition of the printhead can be detected without using an additional apparatus except for two resistances, manufacturing costs of the printhead can be reduced. Furthermore, since the abnormal condition of the printhead can be detected even when the printhead is working, the apparatus and method of the present invention are cost and time-efficient and user-friendly.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to detect an abnormal condition of a printhead, comprising:
a voltage stabilizing unit to stabilize a voltage of a power supplied to the printhead;
a voltage measuring unit to measure a stabilized voltage of the voltage stabilizing unit; and
an abnormal condition detecting unit to compare the measured voltage and a critical voltage to detect an abnormal condition of the printhead in a predetermined time.

2. The apparatus of claim 1, wherein the voltage stabilizing unit comprises a capacitor.

3. The apparatus of claim 2, wherein the abnormal condition detecting unit comprises:
a voltage comparing unit to compare the measured voltage with the critical voltage in the predetermined time and to output a measurement result; and
an abnormal condition detecting unit to operate in response to the voltage comparison result to detect the abnormal condition of the printhead.

4. An apparatus to detect an abnormal condition of a printhead comprising:
a power supply unit to supply a power to the printhead;
a voltage stabilizing unit to stabilize a voltage of the power supplied to the printhead;
a voltage measuring unit to measure the stabilized voltage;
a time measuring unit measure a period of time in which the stabilized voltage reaches a predetermined voltage; and
an abnormal condition detecting unit to compare the measured time with a critical time to detect an abnormal condition of the printhead.

5. The apparatus of claim 4, wherein the voltage stabilizing unit comprises a capacitor.

6. The apparatus of claim 5, wherein the abnormal condition detecting unit comprises:
a time comparing unit to compare the measured time with a critical time and to output a time comparison result; and
an abnormal condition detecting unit to operate in response to the time comparison result to detect the abnormal condition of the printhead.

7. A method of detecting an abnormal condition of the printhead including a capacitor to stabilize a voltage of a power supplied to the printhead, the method comprising:
supplying a power to a capacitor;
detecting a voltage of the capacitor in a predetermined time; and
comparing the measured voltage with a critical voltage and detecting an abnormal condition of the printhead.

8. The method of claim 7, wherein the comparing of the measured voltage with the critical voltage comprises:
comparing the measured voltage with the critical voltage; and
determining that the printhead is in the abnormal condition when the measured voltage is greater than the critical voltage.

9. A method of detecting an abnormal condition of the printhead including a capacitor to stabilize a voltage of a power supply unit to supply a power to the printhead, the method comprising:
stopping supplying a power to a capacitor;
measuring a voltage of the capacitor in a predetermined time; and
comparing the measured voltage with a critical voltage and detecting an abnormal condition of the printhead.

10. The method of claim 9, wherein the detecting of the abnormal condition comprises:
comparing the measured voltage with the critical voltage; and
determining that the printhead is in the abnormal condition when the measured voltage is smaller than the critical voltage.

11. A method of detecting an abnormal condition of the printhead including a capacitor to stabilize a voltage of a power supply unit to supply a power to the printhead, the method comprising:
supplying a power to a printhead;
measuring a time in which a voltage of the capacitor reaches a predetermined voltage; and
comparing the measured voltage with a critical voltage and detecting an abnormal condition of the printhead.

12. The method of claim 11, the comparing of the measured voltage with a critical voltage comprises:
comparing the detected time with a critical time; and
determining that the printhead is in the abnormal condition when the measured time is shorter than the critical time.

13. A method of detecting an abnormal condition of the printhead including a capacitor to stabilize a voltage of power supplied to the printhead, the method comprising:
stopping supplying a power to a printhead;
detecting a time in which a voltage of a capacitor reaches a predetermined voltage; and
comparing the measured time with a critical time and detecting an abnormal condition of the printhead.

14. The method of claim 13, wherein the comparing of the measured time with the critical time comprising:
comparing the measured time with the critical time; and
determining that the printhead is in the abnormal condition when the measured time is shorter than the critical time.

15. A computer readable medium having embodied thereon a computer program for executing the method, the method comprising:
supplying a power to a capacitor;
detecting a voltage of the capacitor in a predetermined time; and
comparing the measured voltage with a critical voltage and detecting an abnormal condition of the printhead.

16. A computer readable medium having embodied thereon a computer program for executing the method, the method comprising:
stopping supplying a power to a capacitor;
measuring a voltage of the capacitor in a predetermined time; and
comparing the measured voltage with a critical voltage and detecting an abnormal condition of the printhead.

17. A computer readable medium having embodied thereon a computer program for executing the method, the method comprising:
supplying a power to a printhead;
measuring a time in which a voltage of the capacitor reaches a predetermined voltage; and
comparing the measured voltage with a critical voltage and detecting an abnormal condition of the printhead.

18. A computer readable medium having embodied thereon a computer program for executing the method, the method comprising:
stopping supplying a power to a printhead;
detecting a time in which a voltage of a capacitor reaches a predetermined voltage; and
comparing the measured time with a critical time and detecting an abnormal condition of the printhead.

19. An apparatus to detect an abnormal condition of a printhead, comprising:
a power supply unit to supply a power to a printhead;
a voltage stabilizing unit to stabilize a voltage of the power supplied to the printhead;
a measuring unit to measure the stabilized voltage of the voltage stabilizing unit and a period of time in which the stabilized voltage reaches a predetermined voltage; and
an abnormal condition detecting unit to detect an abnormal condition of the printhead according to the measured voltage and the measured period of time.

20. An image forming apparatus to detect an abnormal condition of a printhead, comprising:
a power supply unit to supply a power to a printhead;
a voltage stabilizing unit to stabilize a voltage of the power supplied to the printhead;
a measuring unit to measure a voltage variation and a time variation of the voltage stabilizing unit; and
an abnormal condition detecting unit to detect an abnormal condition of the printhead according to the measured voltage variation and the measured time variation.

21. An image forming apparatus to detect an abnormal condition of a printhead, comprising:
a power supply unit to supply a power to a printhead;
a voltage stabilizing unit to stabilize a voltage of the power supplied to the printhead;
a measuring unit to measure a time variation with respect to a variation of the voltage of the voltage stabilizing unit; and
an abnormal condition detecting unit to detect a condition of at least one of the printhead and the power supply unit according to the measured time variation.

22. The apparatus of claim 21, wherein the condition comprises an abnormal condition or a short-circuit condition.

23. The apparatus of claim 21, wherein the abnormal condition detecting unit detects an abnormal condition of the power supply unit according to the measured time variation.

24. The apparatus of claim 21, wherein:
the variation of the voltage comprises a first voltage measured when the power is supplied to the voltage stabilizing unit, a second voltage when the power is stopped from being supplied to the voltage stabilizing unit, and a third voltage a period of time after the power is stopped from being supplied to the voltage stabilizing unit; and
the measuring unit measures the time variation according to at least one of the first voltage, the second voltage, and the third voltage.

25. The apparatus of claim 24, wherein the abnormal condition detecting unit detects the condition of the power supply unit according to the measured time variation and the first voltage.

26. The apparatus of claim 24, wherein the abnormal condition detecting unit detects the condition of the printhead according to the measured time variation and at least one of the second voltage and the third voltage.

27. The apparatus of claim 21, wherein the measuring unit measures the time variation taken to reach from a first value to a second value of the voltage of the voltage stabilizing unit.

28. The apparatus of claim 21, wherein the measuring unit measures a voltage variation of the voltage stabilizing unit, and the abnormal condition detecting unit detects the abnormal condition of the printhead according to the measured time variation and the measured voltage variation.

29. An image forming apparatus to detect an abnormal condition of a printhead, comprising:
a power supply unit to supply a power to a printhead;
a voltage stabilizing unit to stabilize a voltage of the power supplied to the printhead;
a measuring unit to measure a voltage variation with respect to a period of time taken for the voltage variation of the voltage stabilizing unit; and
an abnormal condition detecting unit to detect a condition of at least one of the printhead and the power supply unit according to the measured voltage variation.
